(19) United States
(12) Patent Application Publication
(10) Pub. No.: US 2018/0288230 A1
(43) Pub. Date: Oct. 4, 2018

(54) INTENTION DETECTION AND HANDLING OF INCOMING CALLS

(71) Applicant: International Business Machines Corporation, Armonk, NY (US)

(72) Inventors: Aaron K. Baughman, Silver Spring, MD (US); Gary F. Diamanti, Wake Forest, NC (US); Stephen J. Kenna, Cary, NC (US); Mauro Marzorati, Lutz, FL (US)

(73) Assignee: International Business Machines Corporation, Armonk, NY (US)

(21) Appl. No.: 15/472,847

(22) Filed: Mar. 29, 2017

(51) Int. Cl. H04M 7/00; H04M 3/42; H04M 3/533; G10L 15/02; G10L 15/18; G10L 25/63; G10L 15/00

(52) U.S. Cl. CPC H04M 7/0033; H04M 3/42068; H04M 3/53391; G10L 15/005; G10L 15/1815; G10L 25/63; G10L 15/02

(57) ABSTRACT

A set of characteristics is computed for a caller who is associated with an identifier presented in a caller ID data of a call to a user. A characteristic includes a degree of closeness of the caller to the user in a social network of the user. A classification of the caller is computed using the set of characteristics in a function. A speech feature is extracted from a response from the caller, the response including speech response to an interrogation question presented to the caller during the call, the interrogation question being specific to the classification of the caller. An intent of the caller is determined with a probability using the speech feature. When the probability exceeds a threshold, a call handling instruction is generated for a called system, causing the called system to perform a call handling operation on the call.

### TECHNICAL FIELD

The present invention relates generally to a method, system, and computer program product for managing incoming voice communications. More particularly, the present invention relates to a method, system, and computer program product for Intention detection and handling of incoming calls.

### BACKGROUND

Hereinafter, an electronically conducted voice communication of any kind is interchangeably referred to as a “call” unless expressly disambiguated where used. A call includes human speech comprising verbal expressions in a spoken language, non-verbal sounds, or a combination thereof. Some examples of non-verbal sounds include but are not limited to ambient noise, electrically introduced unintentional noise or disturbance, intentionally introduced electronically generated beeps and other sounds.

A call occurs between a caller system and a called system. A caller system may be a telephone device, a computer system, a robotic telecommunications system, or other type of data processing system configured to initiate a call. A called system can similarly be a telephone device, a computer system, a robotic telecommunications system, or other type of data processing system configured to receive a call. The same system can operate as a caller system for one call and as a called system for another call.

Technology presently exists to allow a called system to route calls to different destination users or devices based on the caller identification (caller ID) data associated with the call. Telecommunications providers provide caller ID data when a caller system places a call to a called system. Typically, the caller ID data includes an identifier—such as a telephone number—being used by the caller system. A geographical location associated with the identifier is either provided in some caller ID data or can be deduced from the caller ID data. If the identifier exists in a contacts list of the called system, the called system can also present a name of an entity associated with the identifier.

Some presently available called systems can automatically route calls from different caller systems based on the caller ID to different users, mailboxes, or other systems. Some presently available called systems can automatically produce different indications—such as different ringtones—for calls originating from different caller systems, based on the caller ID of the caller system.

### SUMMARY

The illustrative embodiments provide a method, system, and computer program product. An embodiment includes a method that computes a set of characteristics associated with a caller who is associated with an identifier presented in a caller ID data of a call to a user, a first characteristic in the set of characteristics comprising a degree of closeness of the caller to the user in a social network of the user. The embodiment computes a classification of the caller using the set of characteristics in a function. The embodiment extracts a speech feature from a response from the caller, the response including speech responsive to an interrogation question presented to the caller during the call, the interrogation question being specific to the classification of the caller. The embodiment computes, to determine an intent of the caller behind the call, a probability of the intent, the computing using the speech feature. The embodiment generates, responsive to the probability exceeding a threshold, a call handling instruction for a called system, wherein the instruction causes the called system to perform a call handling operation on the call.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for Intention detection and handling of incoming calls in accordance with an illustrative embodiment;

FIG. 4 depicts a block diagram of an application for Intention detection and handling of incoming calls in accordance with an illustrative embodiment;

FIG. 5 depicts a flowchart of an example process for caller classification in accordance with an illustrative embodiment; and

FIG. 6 depicts a flowchart of an example process for Intention detection and handling of incoming calls in accordance with an illustrative embodiment.

### DETAILED DESCRIPTION

The illustrative embodiments recognize that caller ID is insufficient to satisfactorily screen incoming calls or to determine an intention of the caller. For example, many caller systems spoof their caller IDs to intentionally misguide a called user (user). Some caller systems, such as those used for telemarketing, cause the caller ID to indicate identifiers that appear familiar or benign to a user. Generally, merely knowing the identifier and even a geographical location from the caller ID is insufficient to determine an intention of the caller in making the call.

The illustrative embodiments further recognize that many called systems allow calls from unfamiliar caller IDs to go to voicemail, where an outgoing greeting from the user is played to the caller and a message is recorded from the caller. Many caller systems are harnessing these played-back outgoing greeting messages to learn personal information about the user—e.g., the correct pronunciation of the user's name, a gender, age, ethnicity, existence/non-existence, in/out schedule, and other such information about the user, which users commonly include in outgoing greetings. The harnessed information is then used against the user to spoof legitimacy in an otherwise undesirable future call to the user.

The illustrative embodiments further recognize that rejecting calls from all unknown callers is also not a good option. For example, often, calls originating from foreign countries are routed through systems that contribute or modify the caller ID data. As a result, even legitimate calls can appear to have unfamiliar caller IDs. Rejecting a call with an unfamiliar caller ID, e.g., by sending the call directly to voicemail or disconnecting the call, can inadvertently reject an expensive or important call from known and familiar callers.

As another example, some users routinely receive legitimate or desirable calls from unfamiliar callers, e.g., a real estate agent receiving a call from a new prospect, etc. Without knowing the intention of the caller, rejecting a call simply based on the unfamiliarity of the caller ID can result in lost opportunities.

Some presently used systems, such as Interactive Voice response (IVR) systems use pre-recorded or pre-configured menus to route incoming calls. An IVR system connects an incoming call to an automated attended which provides a series of options to the caller to choose from. Progressively narrowing IVR options allow the caller to reach the correct user or system during the call.

Some IVR systems allow callers to speak their reason for calling. Such systems extract keywords from the caller's response and guide the call to an IVR menu option that is pre-configured for that keyword.

The illustrative embodiments recognize that even the IVR systems—with or without the spoken response provision—only look for spoken keywords to perform pre-configured call routing operations. A caller can very easily speak the correct keywords to reach an intended user and then pitch a telemarketing or other undesirable communication to the user. Therefore, the illustrative embodiments recognize that the presently available technology and systems for incoming call handling are unsuitable for adequately determining how an incoming call should be handled. A solution is needed that can accurately determine a caller's intention behind the call, and then route or otherwise handle the call based on the identified intent.

The illustrative embodiments recognize that the presently available tools or solutions do not address these needs or provide adequate solutions for these needs. The illustrative embodiments used to describe the invention generally address and solve the above-described problems and other problems related to Intention detection and handling of incoming calls.

An embodiment can be implemented as a software application. The application implementing an embodiment can be configured as a modification of an existing called system—i.e., a native application in the called system, as an application executing in a data processing system communicating with an existing called system over a local area network (LAN)—i.e., a local application on the LAN, as an application executing in a data processing system communicating with an existing called system over a wide area network (WAN)—i.e., a remote application on the WAN, as a separate application that operates in conjunction with an existing telecommunications system, a standalone application, or some combination thereof.

The illustrative embodiments operate on an incoming call. When an incoming call is received, an embodiment determines a set of characteristics associated with the caller. In one embodiment, the caller classification occurs based only on the caller ID being presented by the caller for the call and before the call is connected, i.e., while the call is still ringing. In another embodiment, the caller classification occurs based on the caller ID being presented by the caller before the call is connected as well as with information collected after the call has been connected, i.e., when an embodiment described herein begins caller interrogation.

A caller has a set of characteristics associated therewith. A name, an identifier such as a phone number, a geographical location may be available as some caller characteristics from the caller ID or other existing solutions. The set of caller characteristics according to an embodiment may also include an indication whether the caller is located in a geographical area where the user has greater than a threshold number of contacts. For example, an affirmative indication for a caller from Atlanta if the user has several friends in Atlanta.

The set of caller characteristics according to an embodiment may also include information about a number of calls received from the caller in the past and their average duration. For example, a caller may have called three times over the past week and hung up within 1 minute.

The set of caller characteristics according to an embodiment may also include an indication whether the caller number is of a type in a geographical area where the user has greater than a threshold number of contacts of the type. For example, a type and threshold indication for a business entity caller from Atlanta if the user has several business connections in Atlanta. Assume that the user has a distribution of 25% mobile number connections, 25% home number connections, 40% work number connections, and 15% other types of connections in Atlanta. A caller identified as an unfamiliar business entity, e.g., “XYZ Corp.” in Atlanta, matches a work type connection, of which the user has 40% in Atlanta. Thus, the caller will receive a characteristic—“work” 40%. Another caller identified as an unfamiliar mobile number in Atlanta, matches a mobile type connection, of which the user has 25% in Atlanta. Thus, the caller will receive a characteristic—“work” 40%.

The set of caller characteristics according to an embodiment may also include a direction indication and threshold according to a distribution of inbound and outbound calls from the geographical area where the caller is located. Assume that the user has a distribution of 25% inbound calls from Atlanta and 75% outbound calls to Atlanta. A caller in Atlanta will receive a characteristic—“inbound” direction, 25%.

The set of caller characteristics according to an embodiment may also include crowd-sourced information about the caller. For example, one embodiment performs an online search with the caller's identifier—e.g., the caller ID number, as the search string. Information found from the search can form one or more caller characteristics, e.g., a website of the caller, a site where the caller is reviewed by other users, etc. One embodiment processes the search results to extract information that can be populated as a caller characteristic, e.g., extract the hyperlink to the caller's website, extract only the rating or descriptor associated with the review of the caller, etc.

The set of caller characteristics according to an embodiment includes social network-sourced information about the caller. For example, one embodiment searches the called user's social network to determine whether the caller is within the user's social network, reachable through connections in the user's social network, and how far removed is the caller from the called user in that user's social network. For example, from this exercise of the embodiment, it may turn out that the caller is a friend of a friend, or is five links removed from the user such that a friend of a friend of a friend of a friend has some connection with the caller. Information found from the social network search can form one or more caller characteristics, e.g., presence or absence of the caller in the network, a degree of separation within the network from the user, etc.

These examples of caller characteristics are not intended to be limiting. From this disclosure, those of ordinary skill in the art will be able to conceive many other characteristics that are similarly usable to classify a caller and the same are contemplated within the scope of the illustrative embodiments.

Using the values associated with the characteristics of the caller, an embodiment classifies the caller into one or several classifications. For example, a caller who has made numerous calls of short durations, has a work number, has a “robocall” tag in a crowd-sourced review, and is five levels removed from the user in the user's social network may be classified as a “telemarketer.” As another example, a caller who is calling from where the user has family, has an “other” number, has at least one outgoing call to the caller's number, has no crowd-sourced review, and is associated with someone who is one-level removed from the user in the user's social network may be classified as a “family member.”

As another example, a caller who is calling from a corporation where the called user works, has a “work” number, the called user has several outbound calls to the area code and the Central Office code (CO) (e.g., the idle 3-digits of a US phone number) of the caller, the caller has a “XYZ Corporation” tag in a crowd-sourced review, and is associated with someone who is one-level removed from the user in the user's social network may be classified as a “coworker”.

These examples of combinations of characteristics and the resulting classification are not intended to be limiting. From this disclosure, those of ordinary skill in the art will be able to conceive many other combinations of caller characteristics values, and the classifications that can be configured corresponding to such combinations, and the same are contemplated within the scope of the illustrative embodiments.

In one embodiment, the caller is classified initially based on the characteristics determined using the caller ID data and reclassified, if needed, based on the interrogation responses, as described herein.

Based on the caller's classification, an embodiment selects a subset of interrogation questions from a set of interrogation questions in a repository. One example selection criterion includes a language spoken by the caller (another characteristic if determined about the caller). Those interrogation questions are selected that are in the determined language. Another example selection criterion includes a tone to be adopted with the caller—such as anger, disgust, fear, joy, sadness, polite, authoritative, respectful, formal, etc.—depending on the classification of the caller. For example, if the caller is likely to be a family member, the tone may be respectful in a given language, versus if the caller is likely to be a coworker, the tone is likely to be formal in the given language.

These example caller-classification-specific criteria for selecting the questions are not intended to be limiting. From this disclosure, those of ordinary skill in the art will be able to conceive many other caller-classification-specific criteria for selecting the questions, and the same are contemplated within the scope of the illustrative embodiments.

An embodiment presents a selected interrogation question to the caller during the call. The embodiment receives a response from the caller. The response comprises human speech and optionally one or more non-verbal sound.

The embodiment analyzes the response using a suitable audio/speech analysis methods presently available. The response analysis extracts one or more features of the speech or sounds present in the response. For example, A speech analysis method is able to identify a tone adopted by the caller (an example feature extracted by speech analysis), such as anger, disgust, fear, joy, sadness, polite, authoritative, respectful, formal, etc. The speech analysis method is also able to identify a social propensity of the caller (another example feature extracted by speech analysis) that should be considered—such as openness, conscientiousness, extroversion, agreeableness, and emotional range. The speech analysis method is also able to identify a language style (another example feature extracted by speech analysis) used by the caller, such as analytical, confident, or tentative style. The speech analysis method is also able to identify the ethnicity, locality, regionality, and other such features from the response as well.

Through the analysis of the responses to the subset of interrogation questions, an embodiment is able to compute the values associated with at least some of the caller characteristics. In one embodiment, a deterministic mapping list specifies intention mappings for various combinations of caller characteristics values. For example, if caller characteristics A, B, and C are considered, the combination A=1, B=0, C=0.5 (within certain tolerances) maps to intention 1; the combination A=0.5, B=0.5, C=0.8 (within certain tolerances) maps to intention 2; and so on.

In another embodiment, a probability function computes the probability of the caller's intention being harmful or undesirable as follows—

$$P ( KnownCaller \vert Tone , Social Propensity , Language Style … Ethnicity )$$

$$use the chain rule$$

$$\{ {A}_{1} = KnownCaller , {B}_{1} = Tone , {B}_{2} = Social Propensity , {B}_{3} = Language Style , {B}_{4} = Ethnicity \}$$

$$P ( {A}_{1} \vert {B}_{1} , {B}_{2} , {B}_{3} , {B}_{4} ) = \frac{P ( {B}_{4} \vert {B}_{3} , {B}_{2} , {B}_{1} , {A}_{1} ) P ( {B}_{3} \vert {B}_{2} , {B}_{1} , {A}_{1} ) {P}_{2} ( {B}_{2} \vert {B}_{1} , {A}_{1} ) P ( A )}{P ( {B}_{4} \vert {B}_{3} , {B}_{2} , {B}_{1} ) P ( {B}_{3} \vert {B}_{2} , {B}_{1} ) P ( {B}_{2} \vert {B}_{1} ) P ( {B}_{1} )}$$

$$P ( HarmfulIntention \vert Tone , Social Propensity , Language Style … KnownCaller )$$

$$\{ {A}_{2} = HarmfulIntention , {B}_{1} = Tone , {B}_{2} = Social Propensity , {B}_{3} = Language Style , {C}_{1} = KnownCaller \}$$

$$P ( {A}_{2} \vert {B}_{1} , {B}_{2} , {B}_{3} , {C}_{1} ) = \frac{P ( {C}_{1} \vert {B}_{3} , {B}_{2} , {B}_{1} , {A}_{2} ) P ( {B}_{3} \vert {B}_{2} , {B}_{1} , {A}_{2} ) P ( {B}_{2} \vert {B}_{1} , {A}_{2} ) P ( {A}_{2} )}{P ( {C}_{1} \vert {B}_{3} , {B}_{2} , {B}_{1} ) P ( {B}_{3} \vert {B}_{2} , {B}_{1} ) P ( {B}_{2} \vert {B}_{1} ) P ( {B}_{1} )}$$

The above example equations use some non-limiting example caller characteristics for illustration purposes. Any number of these or other caller characteristics can similarly be used within the scope of the illustrative embodiments. A probability of a caller being known given certain values of certain example caller characteristics is computed. A probability that the intention of the caller is harmful or undesirable in some respect is then computed as shown.

One embodiment further computes a confidence value in the probabilistically or deterministically computed likelihood of harmful intention of the caller. The confidence value in a deterministic model may be a function of a tolerance value. The confidence value in a probabilistic model may be a function of the probability value.

Depending on the computed caller classification, caller-characteristics, and caller intentions, an embodiment generates a suitable instruction for the called system to perform a call handling operation. A call can be handled in a variety of ways. For example, a called system may be configured with several outgoing greetings, and a call handling instruction instructs the called system to play a selected outgoing greeting to the caller.

For example, if the caller is determined to be a telemarketer with an undesirable intention of selling something to the user, the generic machine-generated outgoing greeting may be played to the caller so that no personal information—such as the user's voice signature, pronunciation, schedule, etc., are revealed to the caller. If the caller is determined to be a family member with an undesirable intention, a personal outgoing greeting may be played to the caller so that the greeting is in a recognizable voice but no business schedules etc., are revealed to the caller. If the caller is determined to be a family member with a desirable intention, the call can be connected so that the caller can converse with the user.

If the caller is determined to be a coworker outside business hours, a personal outgoing greeting may be played to the caller so that the greeting is in a recognizable voice and business schedules etc., are revealed to the caller. If the caller is determined to be a coworker during business hours, the call can be connected so that the caller can converse with the user.

These example manners of handling a call are not intended to be limiting. From this disclosure, those of ordinary skill in the art will be able to conceive many other manners in which a call can be handled, and instructions corresponding thereto can be generated, and the same are contemplated within the scope of the illustrative embodiments.

The manner of Intention detection and handling of incoming calls described herein is unavailable in the presently available methods. A method of an embodiment described herein, when implemented to execute on a device or data processing system, comprises substantial advancement of the functionality of that device or data processing system in detecting the intention and classification of a caller and customizing the call handling accordingly.

The illustrative embodiments are described with respect to certain types of characteristics, classifications, response analysis outputs or features, mappings, probabilities, tolerances, instructions, call handling operations, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

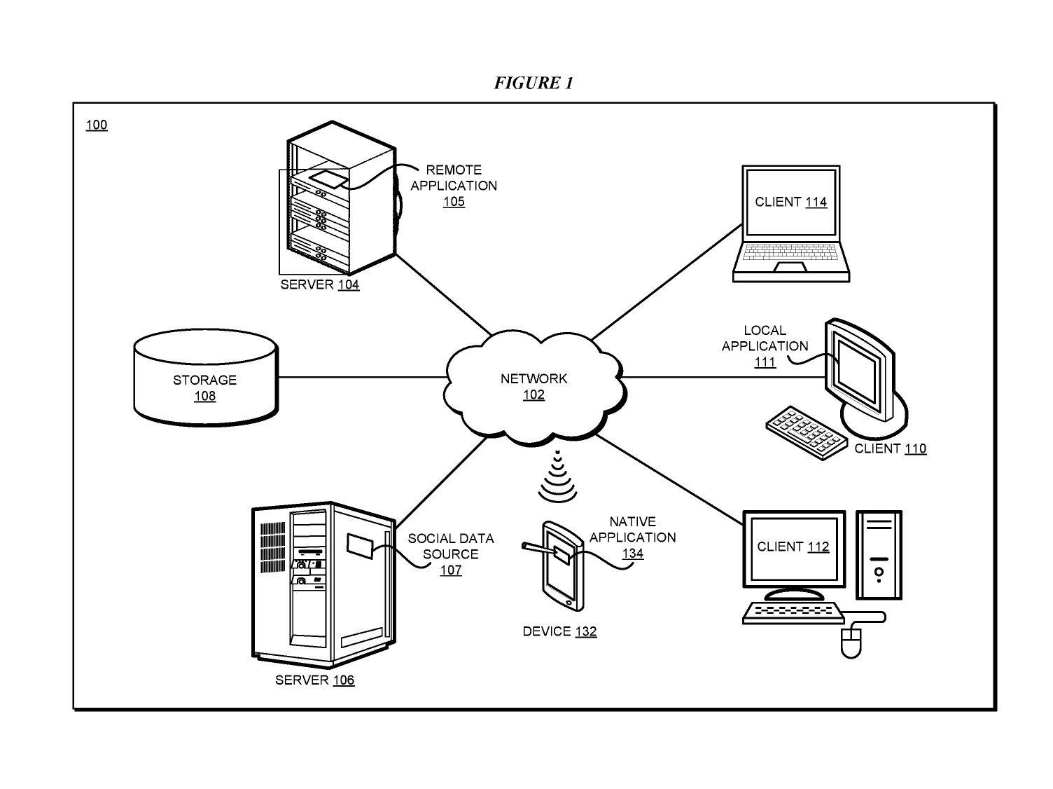

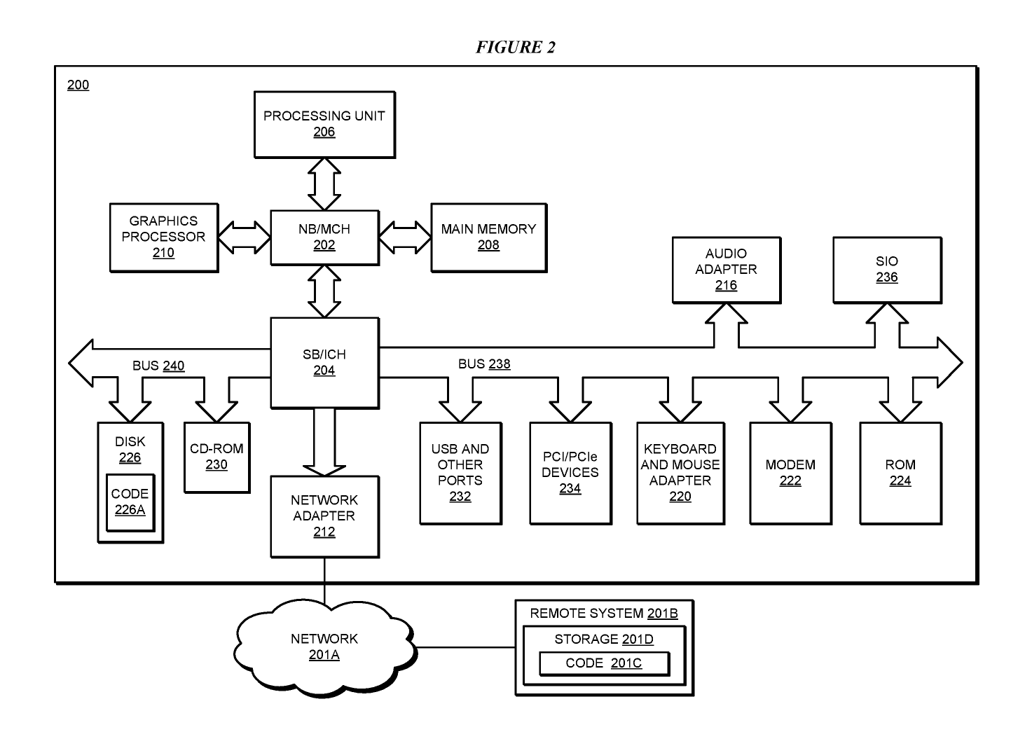

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Any of applications 105, 111, or 134 can be used to implement an embodiment described herein. As a non-limiting example, suppose that device 132 is used as a called device. Application 134 can be implemented as a native application to perform the operations of an embodiment with respect to a call received at device 132. Alternatively, application 111 can be implemented as a local application to perform the operations of an embodiment with respect to a call received at device 132. Alternatively, application 105 can be implemented as a remote application to perform the operations of an embodiment with respect to a call received at device 132. Social data source 107 supplies social media data about the user of device 132 to determine the closeness or familiarity of the caller to the user, such as by application 105, in a manner described herein.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as applications 105, 111, and 134 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

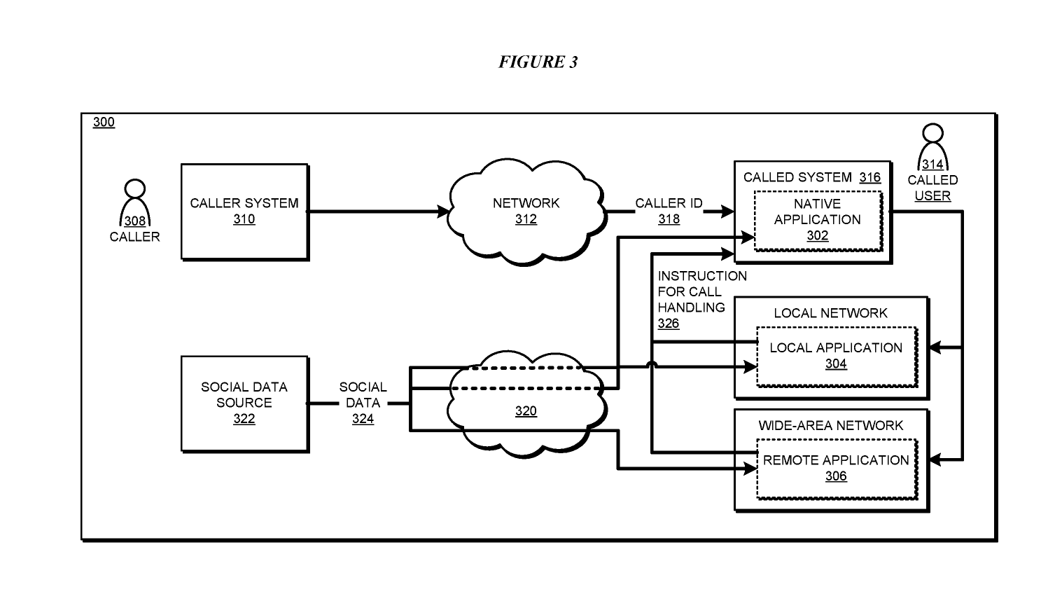

With reference to FIG. 3, this figure depicts a block diagram of an example configuration for Intention detection and handling of incoming calls in accordance with an illustrative embodiment. Application 302 is an example of application 134 in FIG. 1. Application 304 is an example of application 111 in FIG. 1. Application 306 is an example of application 105 in FIG. 1. Note that applications 302, 304, and 306 are not all needed. Any one of these applications can implement the functions described herein. An implementation can choose to distribute these functions across native, local, and remote applications, and such distribution is also contemplated within the scope of the illustrative embodiments.

Caller 308 uses caller system 310 to place a call over network 312 to called user 314. User 314 uses called system 316 to receive the call. Caller ID 318 is received at called system 316, and identifies caller system 310, and by association, caller 308.

Whichever application from applications 302, 304, and 306 is used in an implementation, that application communicates over network 320 with social data source 322 to obtain social data 324. Network 320 can be the same as network 312, e.g., in case of Voice over IP (VoIP) calls, but need not necessarily be the same.

When application 302, or 304, or 306, as the case may be, classifies caller 308, interrogates caller 308, and determines the intention of caller 308, such application generates instruction 326. Instruction 326 causes called system 316 to perform a call handling operation on the call from caller 308, as described herein.

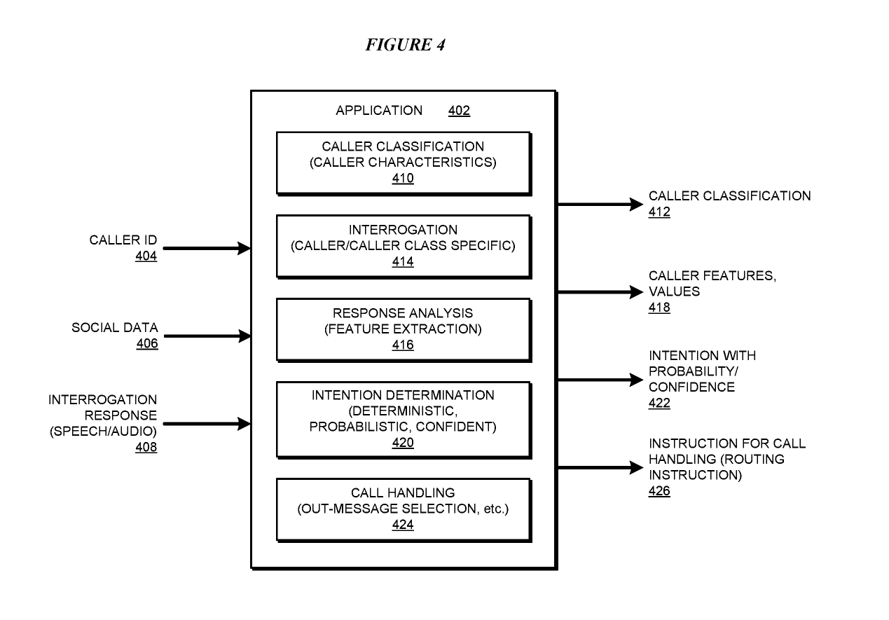

With reference to FIG. 4, this figure depicts a block diagram of an application for Intention detection and handling of incoming calls in accordance with an illustrative embodiment. Application 402 can be used as application 302, 304, 306, or some distributed combination thereof in FIG. 3.

Caller ID input 404 is an example of caller ID 318 in FIG. 3. Social data input 406 is an example of social data 324 in FIG. 3. Interrogation response input 408 comprises human speech and optionally non-verbal audio signals, and are provided by the combination of caller 308 and caller system 310 in FIG. 3.

Component 410 uses inputs 404 and 406 to determine caller characteristics. Based on the determine caller characteristics, component 410 classifies the caller and produces caller classification 412.

Component 414 selects a caller-classification-specific subset of interrogation questions, e.g., from a repository (not shown). Component 414 presents one or more questions from the selected subset to the caller, which elicits response input 408 from the caller.

Component 416 analyzes the speech and/or audio in response input 408 to extract a set of features, in a manner described herein. Component 416 produces a set of features and their corresponding values from the analysis of the responses.

Component 420 performs intention detection. Depending on the implementation, component 420 may use a deterministic method, a probabilistic method, or a combination of the two methods, as described herein. Component 420 produces output 422, which includes a suitable manner of identifying an intention, an associated probability that the caller has that intention, and a confidence value representing a confidence in determining that the caller does have that intention. The intention can be represented in output 422 as a value, a value on a scale, a label, or in any other suitable manner.

Component 424 generates call handling instruction 426. Call handling instruction 426 may cause a called system to select one of several outgoing messages, connect the call to allow the user to converse with the caller, disconnect the call, or take another suitable action depending on the called system capabilities.

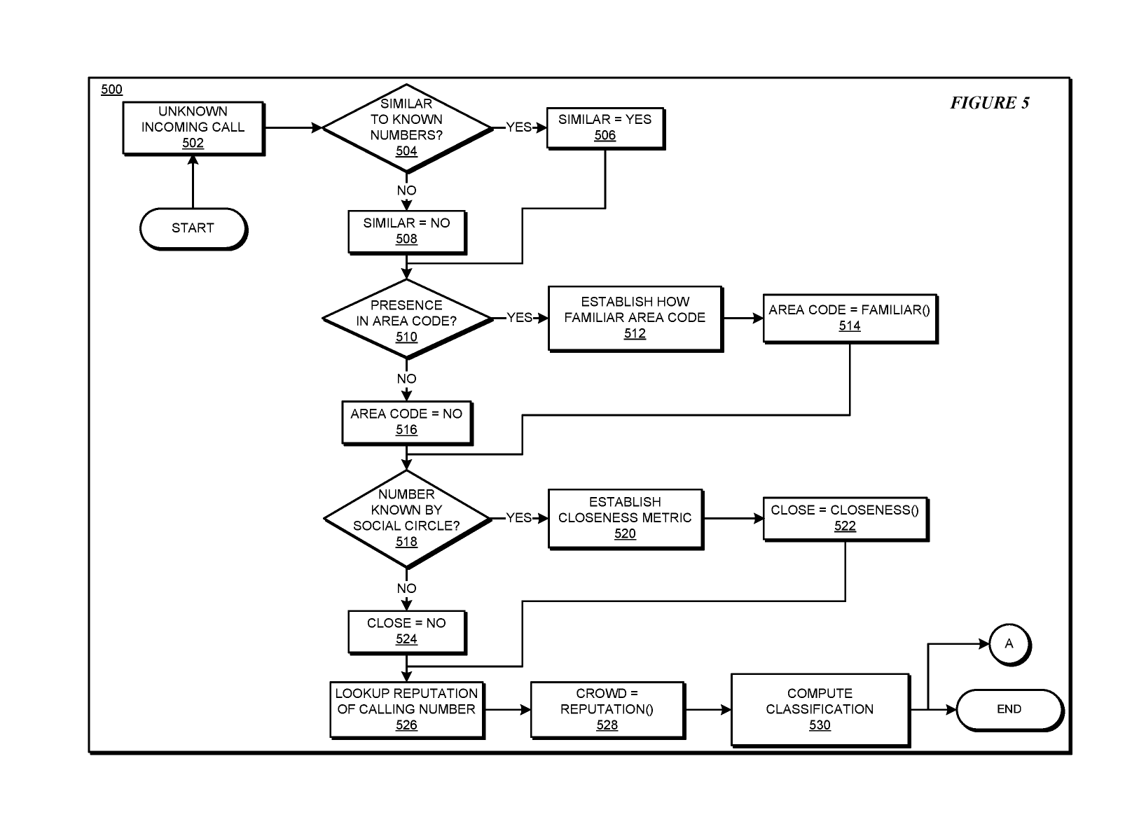

With reference to FIG. 5, this figure depicts a flowchart of an example process for caller classification in accordance with an illustrative embodiment. Process 500 can be implemented in application 402, particularly in component 410, in FIG. 4.

The application receives an unknown incoming call with caller ID (block 502). The application determines whether the number identified in the caller ID is a known number or is similar to numbers known to the called user (block 504). A phone number can be similar to another phone number by having one or more components of the phone numbers the same or within a range. For example, two numbers may be similar if they share the same area code, the same CO code, have area codes from a set of area codes that belong to a common geographic region, have CO codes that are within a range of CO codes, or some combination thereof.

If the number is similar to a known number (“Yes” path of block 504), the application adds a caller characteristic which indicates that the number of the caller is similar to a known number (block 506). If the number is not similar to a known number (“No” path of block 504), the application adds a caller characteristic which indicates that the number of the caller is not similar to a known number (block 508).

The application determines whether the caller's phone number is present in an area code (block 510). A US caller and a US phone number is contemplated in this example, but process 500 can be adapted to handle foreign caller IDs in a similar manner. Even in the US, some caller IDs do not provide the area code information under certain circumstances.

If the number is in an area code (“Yes” path of block 510), the application establishes how familiar the area code is to the user (block 512). For example, the user may have zero, less than a threshold, more than a threshold number of numbers from the area code in the user's contact book. Generally, a familiarity function, familiar ( ), can be configured to establish a degree of familiarity with an area code (block 514). If the area code is not present (“No” path of block 510), the application adds a caller characteristic which indicates that the area code of the caller is not known (block 516).

The application determines whether the caller's phone number is known in the called user's social network (block 518). If the number is known in the called user's social network (“Yes” path of block 518), the application establishes a closeness metric (block 520). For example, a closeness function, closeness ( ), can be configured to establish a degree of closeness of the caller in the user's social network in a manner described herein (block 522). If the phone number is not known in the called user's social network (“No” path of block 518), the application adds a caller characteristic which indicates that the caller is not known in the called user's social network (block 524).

The application looks-up crowd sourced information about the caller, e.g., a reputation of the caller's number (block 526). For example, a reputation function, reputation ( ), can be configured to establish a crowd-sourced reputation metric of the caller based on search results, reviews, and other forms of crowd-sourced data (block 528).

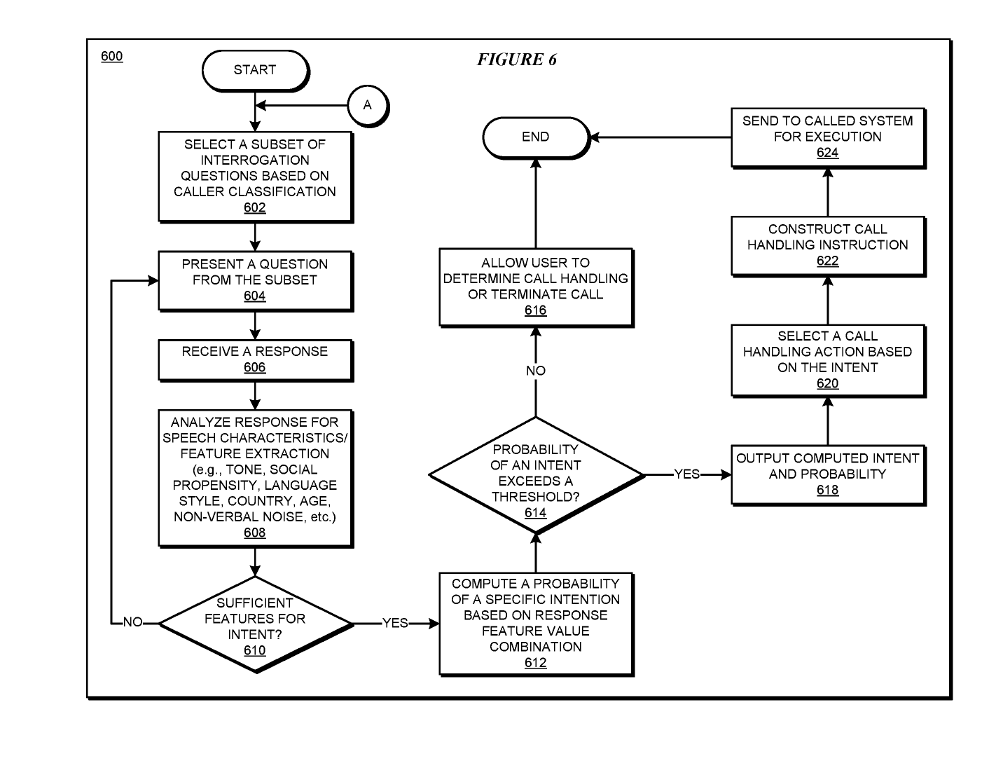

The application computes a classification from the caller characteristic values established in this manner (block 530). The application ends process 500 thereafter, or exists process 500 via exit “A” to enter process 600 in FIG. 6 via corresponding entry “A” therein.

With reference to FIG. 6, this figure depicts a flowchart of an example process for Intention detection and handling of incoming calls in accordance with an illustrative embodiment. Process 600 can be implemented in application 402 in FIG. 4. Process 600 may be entered from process 500 via entry point “A”.

The application selects a subset of interrogation questions based on the caller classification (block 602). The application presents a question from the subset to the caller (block 604). The application receives a response (block 606). The application analyzes the response for speech characteristics, i.e., feature extraction, in a manner described herein (block 608).

The application determines whether sufficient features have been extracted, i.e., sufficient number of speech features and their corresponding values have been computed, for intent identification (block 610). If sufficient features have not yet been extracted (“No” path of block 610), the application returns to block 604 to present more questions.

If sufficient features have been extracted (“Yes” path of block 610), the application computes a probability of a specific intent based on the combination of the feature values computed from the responses (block 612). The particular intent can be harmful or undesirable, as described herein, but process 600 can also be adapted to determine favorable or desirable intents in a similar manner within the scope of the illustrative embodiments.

The application determines whether the computed probability of a computed intent exceeds a threshold (block 614). For example, if the computed intent is a harmful one, and if the probability does not exceed the threshold (“No” path of block 614), the application may allow the user to determine the call handling, e.g., converse with the caller (block 616). As another example, if the computed intent is a benign one, and if the probability does not exceed the threshold (“No” path of block 614), i.e., the intent turns out to be a harmful one when a benign intent was expected, the application may terminate the call at block 616.

If the probability of the computed intent exceeds the threshold (“Yes” path of block 614), the application outputs a computed intent and probability (block 618). The application selects a call handling action based on the intent (block 620). The application constructs a call handling instruction (block 622). The application sends the instruction to the called system for execution (block 624). The application ends process 600 thereafter.

Thus, a computer implemented method, system or apparatus, and computer program product are provided in the illustrative embodiments for Intention detection and handling of incoming calls and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method comprising:
traversing a social network of a user, the traversing determining a number of links between the user and a set of other users in the social network, the set of other users including a caller who is associated with an identifier presented in a caller ID data of a call to the user;
computing a set of characteristics associated with the caller, a first characteristic in the set of characteristics comprising a degree of closeness of the caller to the user in the social network, wherein the degree of closeness is a function of the number of links in the social network that separate the user from the caller;
computing a classification of the caller using the set of characteristics in a function;
extracting a speech feature from a response from the caller, the response including speech responsive to an interrogation question presented to the caller during the call, the interrogation question being specific to the classification of the caller;
computing, to determine an intent of the caller behind the call, a probability of the intent, the computing using the speech feature; and
generating, responsive to the probability exceeding a threshold, a call handling instruction for a called system, wherein the instruction causes the called system to perform a call handling operation on the call.

2. The method of claim 1, further comprising:
selecting a subset of interrogation questions from a set of interrogation questions, the selecting being based on the caller classification, and wherein the subset includes the interrogation question.

3. The method of claim 2, further comprising:
presenting a second interrogation question from the subset, responsive to determining that additional speech features are needed to determine the intent;
extracting a second speech feature from a second response to the second interrogation question; and
using the second speech feature in the computing of the probability.

4. The method of claim 1, wherein the speech feature is a tone of the caller.

5. The method of claim 1, wherein the speech feature is a language style adopted by the caller.

6. The method of claim 1, wherein the speech feature is a social propensity of the caller.

7. The method of claim 1, further comprising:
analyzing the caller ID data to determine whether the identifier is similar to a second identifier known to the user, wherein a second characteristic in the set of characteristics comprises a degree of similarity between the identifier and the second identifier.

8. The method of claim 7, wherein the identifier is similar to the second identifier by having a portion of the identifier and a corresponding portion of the second identifier within a set of portion values.

9. The method of claim 8, wherein the portion comprises a Central Office (CO) code.

10. The method of claim 8, wherein the portion comprises an area code.

11. The method of claim 8, wherein the portion comprises an area code and a CO code.

12. (canceled)

13. The method of claim 1, further comprising:
searching crowd-sourced data using the identifier in a query; and
computing a value of a second characteristic in the set of characteristics based on a tag associated with the identifier in the crowd-sourced data.

14. The method of claim 1, wherein the call handling operation comprises: selecting one of a plurality of outgoing messages configured for the user; and playing the selected outgoing message to the caller.

15. A computer usable program product comprising one or more computer-readable storage devices, and program instructions stored on at least one of the one or more storage devices, the stored program instructions comprising:
program instructions to traverse a social network of a user, the traversing determining a number of links between the user and a set of other users in the social network, the set of other users including a caller who is associated with an identifier presented in a caller ID data of a call to the user;
program instructions to compute a set of characteristics associated with the caller, a first characteristic in the set of characteristics comprising a degree of closeness of the caller to the user in the social network, wherein the degree of closeness is a function of the number of links in the social network that separate the user from the caller;
program instructions to compute a classification of the caller using the set of characteristics in a function;
program instructions to extract a speech feature from a response from the caller, the response including speech responsive to an interrogation question presented to the caller during the call, the interrogation question being specific to the classification of the caller;
program instructions to compute, to determine an intent of the caller behind the call, a probability of the intent, the computing using the speech feature; and
program instructions to generate, responsive to the probability exceeding a threshold, a call handling instruction for a called system, wherein the instruction causes the called system to perform a call handling operation on the call.

16. The computer usable program product of claim 15, further comprising:
program instructions to select a subset of interrogation questions from a set of interrogation questions, the selecting being based on the caller classification, and wherein the subset includes the interrogation question.

17. The computer usable program product of claim 16, further comprising:
program instructions to present a second interrogation question from the subset, responsive to determining that additional speech features are needed to determine the intent;
program instructions to extract a second speech feature from a second response to the second interrogation question; and
program instructions to use the second speech feature in the computing of the probability.

18. The computer usable program product of claim 15, wherein the computer usable code is stored in a computer readable storage device in a data processing system, and wherein the computer usable code is transferred over a network from a remote data processing system.

19. The computer usable program product of claim 15, wherein the computer usable code is stored in a computer readable storage device in a server data processing system, and wherein the computer usable code is downloaded over a network to a remote data processing system for use in a computer readable storage device associated with the remote data processing system.

20. A computer system comprising one or more processors, one or more computer-readable memories, and one or more computer-readable storage devices, and program instructions stored on at least one of the one or more storage devices for execution by at least one of the one or more processors via at least one of the one or more memories, the stored program instructions comprising:
program instructions to traverse a social network of a user, the traversing determining a number of links between the user and a set of other users in the social network, the set of other users including a caller who is associated with an identifier presented in a caller ID data of a call to the user;
program instructions to compute a set of characteristics associated with the caller, a first characteristic in the set of characteristics comprising a degree of closeness of the caller to the user in the social network, wherein the degree of closeness is a function of the number of links in the social network that separate the user from the caller;
program instructions to compute a classification of the caller using the set of characteristics in a function;
program instructions to extract a speech feature from a response from the caller, the response including speech responsive to an interrogation question presented to the caller during the call, the interrogation question being specific to the classification of the caller;
program instructions to compute, to determine an intent of the caller behind the call, a probability of the intent, the computing using the speech feature; and
program instructions to generate, responsive to the probability exceeding a threshold, a call handling instruction for a called system, wherein the instruction causes the called system to perform a call handling operation on the call.
